(19) United States
(12) Patent Application Publication
(10) Pub. No.: US 2019/0344390 A1
(43) Pub. Date: Nov. 14, 2019

(54) Mobile Weld Inspection Carriage

(71) Applicant: James M. Cain, Montgomery, TX (US)

(72) Inventor: James M. Cain, Montgomery, TX (US)

(21) Appl. No.: 16/409,123

(22) Filed: May 10, 2019

Related U.S. Application Data
(60) Provisional application No. 62/669,731, filed on May 10, 2018.

(51) Int. Cl. B23K 31/12; F16L 55/32; F16L 55/40

(52) U.S. Cl. CPC B23K 31/125; B23K 9/048; F16L 55/40; F16L 55/32

(57) ABSTRACT

A carriage for inspecting the integrity of a spiral weld in a tubular is arranged to be driven axially within the tubular by the weld as the tubular is rotated. The carriage includes one or more transducers for transmitting to and receiving data from the weld.

This application claims priority to Provisional Patent Application Ser. No. 62/669731 filed May 10, 2018, the entire contents of which is hereby incorporated herein by reference thereto.

### BACKGROUND OF THE INVENTION

### Field of the Invention

This invention is directed to a mobile weld inspection device that is configured to travel along a spiral weld in a tubular. The device includes wheels and two pairs of rollers that engage the weld. Rotation of the tubular results in the carriage being directed axially along the tubular. Weld integrity sensors analyze the integrity of the weld and can transmit data to a central processing unit either wirelessly or wired.

### Description of Related Art

Prior Art inspection systems for a spiral or circular weld in a tubular required a stationary support with a cantilevered beam which carries weld sensors. A wheeled support trunk rotatably carries the tubular and allows for rotation of the tubular while the weld transducer remain stationary. Wide rings at either end of the tubular retain water within the bottom of the tubular as the tubular is rotated.

The prior art is burdensome and requires several distinct components including the cantilevered beam and support, a support car for supporting, rotating, and axially translating the tubular.

### BRIEF SUMMARY OF SOME OF THE PREFERRED EMBODIMENTS

The present invention overcomes the problems associated with the prior art by the provision of a mobile carriage that is axially moved within the tubular along the spiral weld by rotation of the tubular.

The carriage includes sensors and records data received from transducers positioned adjacent the spiral or circular weld as the tubular is rotated.

The carriage may also be adapted to travel along a longitudinal weld by providing a motor and a driven wheel on the carriage so that rollers will tract on either side of the weld thereby guiding the carriage in a longitudinal direction along the weld.

The carriage may also be used to track a circular weld by rotation of the tubular.

### BRIEF DESCRIPTION OF THE DRAWINGS

For a detailed description of the preferred embodiments of the invention, reference will now be made to the accompanying drawings in which:

FIG. 1 is a bottom view of the carriage according to a first embodiment of the invention.

FIG. 2 is a side view of the carriage.

FIG. 3 is a view showing the carriage positioned within a tubular.

### DETAILED DESCRIPTION OF THE PREFERRED EMBODIMENTS

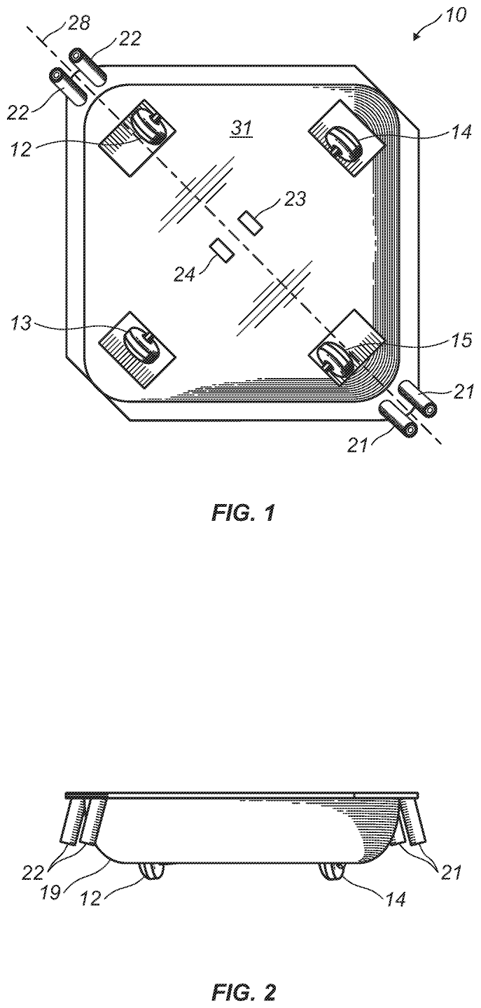

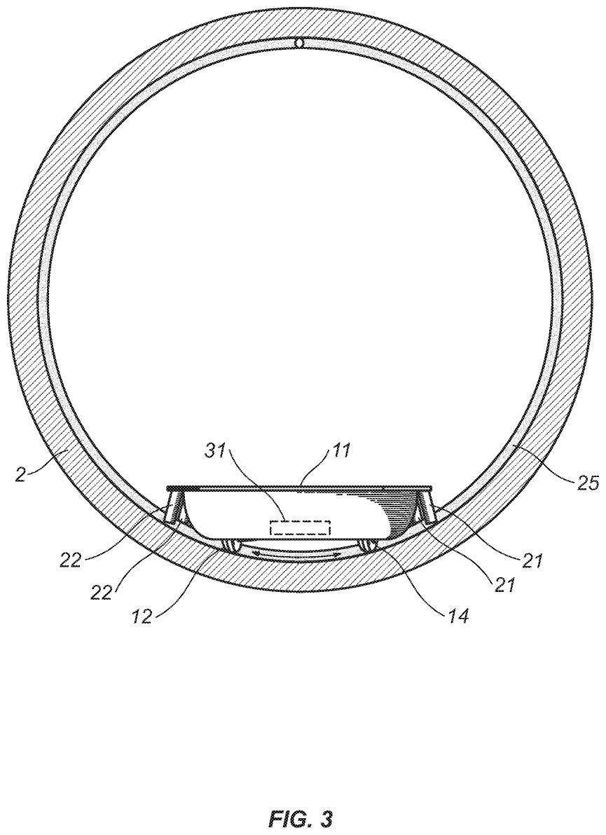

As shown in FIG. 1, the carriage 10 includes a housing 11 that is generally rectangular in shape at an upper portion thereof and has a curved bottom 19 that generally conforms to the curved portion of the tubular as shown in FIG. 3. The lower portion 31 of the bottom in generally rectangular in shape but may be curved.

The lower portion of the housing includes four wheels 12, 13, 14, 15, that are mounted in such a manner so as the tubular is rotated, the wheels are in contact with the inner surface of the tubular, which is generally circular. The wheels may be caster wheels. Wheels 12 and 15 are positioned on opposite sides of the weld in use, and may or may not engage the weld.

A first pair of rollers 22 extend downwardly and at a slight angle with respect to a vertical axis. A second pair of rollers 21 are positioned diagonally across from rollers 22 at the bottom of the carriage so that the weld line 28 is positioned between the two pairs of rollers as shown in FIG. 1. The rollers may be configured and arranged to track welds of different shapes and sizes.

With the weld physically positioned between the pairs of rollers as shown in FIG. 3, rotation of the tubular 2 will cause axial movement of the carriage along the bottom of the tubular. Ultrasonic transducers 23 and 24 will be positioned on both sides of the weld and will transmit data to a ultrasonic phased array instrument 31 that may be attached to the carriage or may be located outside of the tubular.

Transducer 24 and 25 send signals via antennas to the processing and control unit. Each end of the tubular 2 may be fitted with a circular rim to maintain a level of liquid in the bottom of the tubular in accordance with the technique disclosed in U.S. Pat. No. 8,215,174, the entire contents of which is hereby expressly incorporated herein by reference thereto.

Carriage 10 may also be equipped with an encoder to measure the axial distance traveled by the carriage. This information can also be wirelessly transmitted to the processing and central unit.

The carriage may also be provided with a laser measuring device to record the axial position of the carriage within the tubular.

During the inspection the tubular is rotated but it is not moved in a horizontal direction. The exterior shape of the housing is configured so that the carriage will be able to roll within the inner surface of the tubular as the tubular is rotated.

What is claimed is:

1. A carriage for inspecting the integrity of a spiral weld in a tubular comprising;
a) a housing,
b) a plurality of wheels for supporting the housing on the interior surface of a tubular, and
c) means for transferring rotational movement of the tubular into axial movement of the carriage along the tubular by engagement with the spiral weld.

2. The carriage as claimed in claim 1 wherein the wheels are caster wheels.

3. The carriage as claimed in claim 1 wherein the housing includes a bottom having a generally rectangular shape and the wheels are located at the four corners of the rectangle.

4. The carriage as claimed in claim 3 wherein the means for transferring rotational movement of the tubular into axial movement of the carriage includes two pairs of rollers, each pair located at diagonal corners of the rectangular housing bottom.

5. The carriage of claim 4 wherein the rollers are disposed in a generally vertical position and extend downwardly from a top portion of the housing to engage either sides of the weld.

6. A method of inspecting the integrity of a weld in a tubular comprising;
a) providing a carriage equipped with transducers for axial movement within the tubular,
b) rotating the tubular about a horizontal axis while in a stationary condition,
c) causing the carriage to move axially within the tubular.

7. The method of claim 6 further including causing the carriage to move axially with the tubular by means engaging either side of the spiral weld.

8. The method of claim 6 wherein the weld is a spiral weld and the carriage is axially moved by engagement with the spiral weld.
